(19) United States
(12) Patent Application Publication
(10) Pub. No.: US 2025/0356655 A1
(43) Pub. Date: Nov. 20, 2025

(54) PERSON TRACKING SUPPORT DEVICE

(71) Applicant: TOYOTA JIDOSHA KABUSHIKI KAISHA, Aichi-ken (JP)

(72) Inventors: Ryuya NISHINO, Tokyo-to (JP); Hsuan-Kung YANG, Tokyo-to (JP); Hitoshi KAMADA, Tokyo-to (JP); Norimasa KOBORI, Tokyo-to (JP)

(21) Appl. No.: 19/200,667

(22) Filed: May 7, 2025

(30) Foreign Application Priority Data
May 17, 2024 (JP) 2024-081078

(51) Int. Cl. G06V 20/52; G06V 10/25; G06V 10/26; G06V 40/16

(52) U.S. Cl. CPC G06V 20/52; G06V 10/25; G06V 10/273; G06V 40/172

(57) ABSTRACT

A person tracking support device identifies persons appearing in at least one of videos, and displays a person tracking screen including a first display section that synchronously reproduces monitoring videos selected from the videos and a second display section that displays an appearance section in which the person appears in at least one of the monitoring videos for each persons. When a user performs an operation of designating a time point of the appearance section related to a target person on the person tracking screen, the person tracking support device displays a snapshot of the monitoring videos at the time point on the first display section, and displays person tracking information for the user to recognize a portion in which the target person appears in the snapshot on the person tracking screen.

### CROSS-REFERENCE TO RELATED APPLICATION

The present application claims priority under 35 U.S.C. § 119 to Japanese Patent Application No. 2024-081078, filed on May 17, 2024, the contents of which application are incorporated herein by reference in their entirety.

### TECHNICAL FIELD

The present disclosure relates to a technique for supporting tracking of a person appearing in a video captured by a camera.

### BACKGROUND ART

Patent Literature 1 discloses a crime prevention system that identifies suspicious behavior of a person included in a camera image. The security system monitors the behavior of a person included in a plurality of camera images continuously captured along a time series by a monitoring camera. The crime prevention system detects a person region of each of persons included in a plurality of camera images, and performs tracking processing for identifying the persons included in the plurality of camera images in time series on the basis of person image data included in the person region. Then, when the identification by the tracking processing transitions to failure in the middle, the security system determines that the person of the suspicious behavior is included in the camera image.

In addition, as documents showing the technical level of the present technical field, there are the following Patent Documents 2 and 3.

### LIST OF RELATED ART

Patent Document 1: Japanese Patent Application Laid-Open No. 2023-086471
Patent Document 2: Japanese Patent Application Laid-Open No. 2023-156963
Patent Document 3: Japanese Patent Application Laid-Open No. 2024-032346

### SUMMARY

A case where a user tries to track a specific person appearing in a video while checking the video will be considered. In this case, the tracking of the person is normally performed over a plurality of videos captured by a plurality of cameras. Therefore, the user who tracks the person is required to locate the person to be tracked during the video time for each of the plurality of videos. Conventionally, this tracking operation requires a considerable amount of human cost or time cost.

The present disclosure has been made in view of the above problems. An object of the present disclosure is to provide a technique that enables efficiency improvement of a tracking operation when a user tracks a person shown in a video.

One aspect of the present disclosure relates to a person tracking support device.

The person tracking support device includes:
a storage device configured to store data of a plurality of videos captured by a plurality of cameras; and
processing circuitry.

The processing circuitry is configured to:
identify one or more persons in at least one of the plurality of videos; and
display a person tracking screen on a display device, the person tracking screen including a first display section that synchronously reproduces and displays one or more monitoring videos selected from the plurality of videos during a video time, and a second display section that displays an appearance section for each of the one or more persons, the appearance section being a section in which the person appears in at least one of the one or more monitoring videos during the video time.

The processing circuitry is further configured to, when a user performs an operation of designating a time point of the appearance section related to a target person among the one or more persons on the person tracking screen:
display a snapshot of the one or more monitoring videos at the time point on the first display section; and
display person tracking information on the person tracking screen, the person tracking information being information for causing the user to recognize a portion in which the target person appears in the snapshot.

According to the present disclosure, a person tracking screen is displayed, the person tracking screen including a first display unit that synchronously reproduces and displays one or more selected monitoring videos during a video time, and a second display section that displays an appearance section that appears in at least one of the one or more monitoring videos during the video time for each of one or more identified persons. This allows the user to easily determine in which section each person appearing in the video is displayed. Then, when the user performs an operation of designating one time point of the appearance section related to the target person, a snapshot of one or a plurality of monitoring videos at the one time point and the person tracking information are displayed. Thus, the user can easily recognize the portion in which the target person appears at each time point during the appearance section. As described above, according to the present disclosure, it is possible to improve the efficiency of the tracking work by the user.

### BRIEF DESCRIPTION OF DRAWINGS

FIG. 1 is a conceptual diagram for explaining an overview of a person tracking support device according to an embodiment.

FIG. 2 is a block diagram showing a basic configuration of the person tracking support device according to the embodiment.

FIG. 3 is a block diagram showing a functional configuration related to processing executed by the person tracking support device according to the embodiment.

FIG. 4 is a diagram showing an example of person identification information generated by the person identifying section shown in FIG. 3.

FIG. 5 is a diagram showing an example of a screen configuration of a person tracking screen.

FIG. 6 is a diagram for explaining an operation when a user tracks a target person on a person tracking screen.

FIG. 7 is a diagram showing a processing sequence in the case where the user tracks a target person on a person tracking screen.

FIG. 8 is a conceptual diagram for explaining display of a virtual space image.

### DETAILED DESCRIPTION

Hereinafter, embodiments of the present disclosure will be described with reference to the accompanying drawings. In the drawings, the same or corresponding components are denoted by the same reference numerals, and the description thereof will be simplified or omitted.

### 1. Person Tracking Support Device

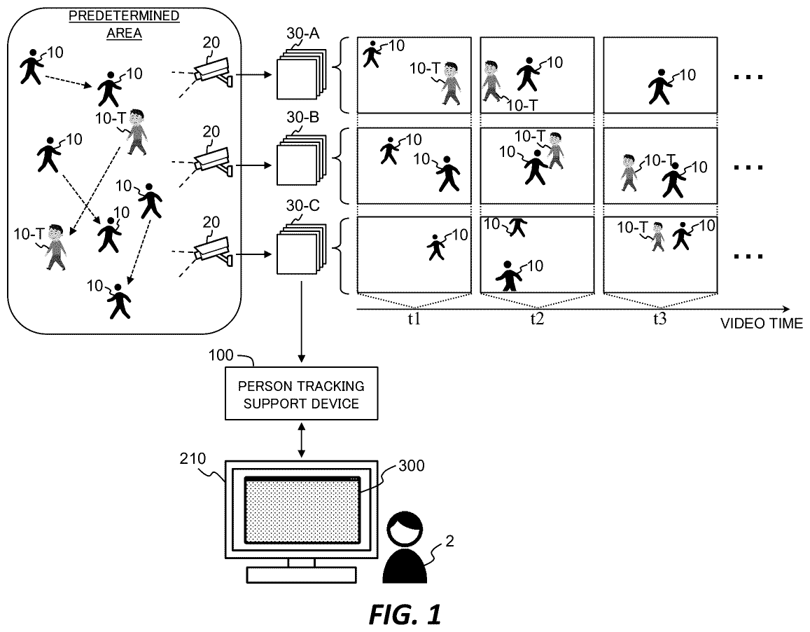

FIG. 1 is a conceptual diagram for explaining an overview of the person tracking support device 100. The person tracking support device 100 acquires a plurality of videos 30 captured by a plurality of cameras 20. Each camera 20 is arranged to monitor the person 10 moving in the predetermined area. The predetermined area may be a town, a building, or the like. The person 10 may also be referred to as a “pedestrian 10”. The plurality of cameras 20 may include two or more cameras that capture the same point from different viewpoints.

The person tracking support device 100 displays a “person tracking screen 300” for supporting the user 2 to track the person 10 shown in the video 30 on the display device 210 by using the data of the plurality of acquired videos 30. The user 2 tracks the person 10 shown in the video 30 on the person tracking screen 300. The person tracking screen 300 will be described in detail later. Tracking the person 10 in the video 30 is useful in the field of traffic management, behavior analysis, and the like.

Here, a case where the user 2 tries to track a specific person 10-T (hereinafter, referred to as a “target person 10-T”) will be considered. At this time, the user 2 needs to look at the target person 10-T during the video time for each of the plurality of videos 30. In the example shown in FIG. 1, frames at time points t1, t2, and t3 of the video time are shown for each of the three videos 30 (30-A, 30-B, and 30-C). In the example illustrated in FIG. 1, the user 2 confirms that the target person 10-T is shown in the video 30-A from the time point t1 to the time point t2, and tracks the target person 10-T. Similarly, the user 2 confirms that the target person 10-T is shown in the video 30-B from the time point t2 to the time point t3 and the target person 10-T is shown in the video 30-C at the time point t3, and tracks the target person 10-T. In this way, in the tracking work of tracking the target person 10-T shown in the video 30, the user 2 needs to confirm which section and which camera 20 show the target person 10-T in the video 30. In particular, when the target person 10-T is tracked over a plurality of videos 30, it is necessary to determine the same person as the target person 10-T from among the persons 10 appearing in the different videos 30. Conventionally, such a tracking operation by the user 2 requires a considerable human cost or time cost. The present embodiment proposes the person tracking support device 100 that displays the person tracking screen 300 that enables the user 2 to efficiently perform the tracking work.

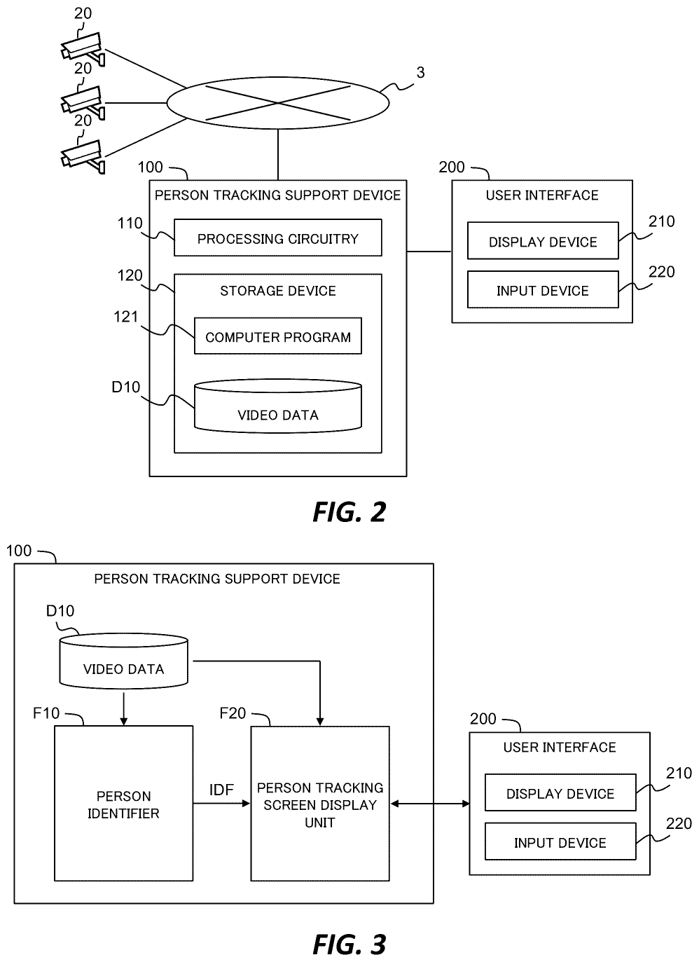

FIG. 2 is a block diagram showing a basic configuration of the person tracking support device according to the present embodiment. The person tracking support device 100 is a computer including a processing circuitry 110 and one or more storage devices 120 (hereinafter, simply referred to as “storage device 120”). The person tracking support device 100 is connected to a plurality of cameras 20 via a communication network 3. The communication network 3 is configured by, for example, a wired communication system, a wireless communication system, the Internet, or the like. The person tracking support device 100 is connected to a user interface 200 including a display device 210 and an input device 220. The display device 210 performs various displays in accordance with an output from the person tracking support device 100. In particular, the display device 210 displays the person tracking screen 300. The display device 210 is configured by, for example, a display, a projector, a head mounted display (HMD), or the like. The input device 220 receives various inputs from the user 2 to the person tracking support device 100. The input device 220 is configured by, for example, a keyboard, a pointing device, a touch pad, a switch, a microphone, and the like. The person tracking support device 100 may be a server accessible via the communication network 3. In this case, the user interface 200 may be a user terminal (for example, a personal computer, a smartphone, a tablet, or the like) connected to the person tracking support device 100 via the communication network 3.

The processing circuitry 110 executes various kinds of processing. The processing circuitry 110 may be implemented as, for example, a general-purpose processor, a special-purpose processor, a central processing unit (CPU), a graphics processing unit (GPU), an application specific integrated circuit (ASIC), a field-programmable gate array (FPGA), an integrated circuit, a conventional circuit, or a combination of one or more of these. A processor including transistors and other circuits is an example of the processing circuitry 110. The processing circuitry 110 may also be referred to as circuitry. The circuitry may be hardware programmed to implement or perform the functions described in this disclosure.

The storage device 120 stores various kinds of information necessary for execution of processing of the processing circuitry 110. The storage device 120 is configured by a recording medium such as a random access memory (RAM), a read only memory (ROM), a solid state drive (SSD), or a hard disk drive (HDD). The storage device 120 stores a computer program 121 executable by the processing circuitry 110. The computer program 121 is configured by a plurality of instructions describing processing to be executed by the processing circuitry 110. The computer program 121 may be recorded in a computer-readable recording medium. The processing circuitry 110 that executes the computer program 121 and the storage device 120 cooperate with each other to realize the functions of the person tracking support device 100.

The storage device 120 further stores a video data D10. The video data D10 is used to manage the plurality of videos 30 captured by the plurality of cameras 20. The person tracking support device 100 acquires the video 30 captured by each camera 20, and records and manages the acquired video 30 in the video data D10. The person tracking support device 100 may sequentially acquire the video 30 from each camera 20 online. The person tracking support device 100 may acquire the video 30 from the user 2 via the input device 220. Each video 30 managed in the video data D10 includes information on the time of image capture and information on the camera 20 that captured the video 30.

FIG. 3 is a block diagram illustrating a functional configuration related to processing executed by the person tracking support device 100. The person tracking support device 100 includes a person identifier F10 and a person tracking screen display unit F20 as functional blocks. These functional blocks are realized by cooperation of the processing circuitry 110 that executes the computer program 121 and the storage device 120.

The person identifier F10 performs an identification process of identifying one or more persons 10 appearing in at least one of the plurality of videos 30 managed by the video data D10, and generates person identification information IDF. By executing the identification process, unique identification information (ID) is assigned to each identified person 10. In addition, by executing the identification process, a portion in which each identified person 10 appears in each video 30 is specified. The portion of the video 30 in which the person 10 appears is represented by, for example, a bounding box surrounding the person 10. That is, in this case, the position of the bounding box is specified by the execution of the identification processing. The portion of the video 30 where the person 10 appears can be represented in other forms such as a polygon surrounding the person 10 or the skeleton position of the person 10. In the following description, a case where the position of the bounding box is specified by executing the identification processing will be considered.

The identification processing typically includes tracking processing for detecting the person 10 appearing in the video 30 and tracking the detected person 10 in the video, and human re-identification processing for identifying the same person 10 between different videos 30. The tracking process and the person re-identification process are well-known techniques, and the methods thereof are not particularly limited. For example, the identification process can be implemented by an AI pipeline including a learned machine learning model configured to perform a tracking process and a person re-identification process using the plurality of videos 30 as inputs.

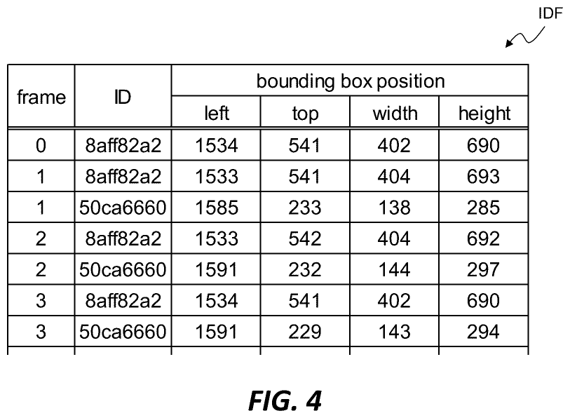

The person identification information IDF is information in which, for each of the plurality of videos 30, the ID of the person 10 shown in the video 30 for each frame is associated with a portion of the video 30 in which the person 10 of the ID is shown. FIG. 4 is a diagram showing an example of person identification information IDF related to one of the plurality of videos 30. In the example illustrated in FIG. 4, for each of the 0th to 3rd frames, the ID of the person 10 shown in the video 30 and the position of the bounding box surrounding the person 10 of the ID in the video 30 are shown in association with each other. The position of the bounding box is defined by the positions of the left end (left) and the top end (top) and the values of the width (width) and the height (height). According to the example shown in FIG. 4, it is understood that the person 10 of the identifier “8aff82a2” is shown in the video 30 in the section of the 0th to 3rd frames. It is also understood that the person 10 with the identifier “50ca6660” is shown in the video 30 in the section of the first to third frames. In particular, the position of the bounding box surrounding these persons 10 in each frame is known.

By referring to the person identification information IDF generated by the person identifier F10 in this way, it is possible to acquire the section in which each identified person 10 is shown in the video 30 and the portion shown in the video 30 for each of the plurality of videos 30. The person identifier F10 may store the generated person identification information IDF in the storage device 120.

Refer to FIG. 3 again. The person tracking screen display unit F20 generates the person tracking screen 300 based on the plurality of videos 30 managed by the video data D10 and the person identification information IDF acquired from the person identifier F10, and displays the person tracking screen 500 on the display device 210. The person tracking screen display unit F20 receives an operation input from the user 2 to the person tracking screen 300 displayed on the display device 210 via the input device 220. The person tracking screen display unit F20 changes the display of the person tracking screen 300 in response to the operation input from the user 2.

The person tracking screen 300 displayed on the display device 210 by the person tracking screen display unit F20 will be described in detail below.

### 2. Person Tracking Screen

### 2-1. Screen Configuration

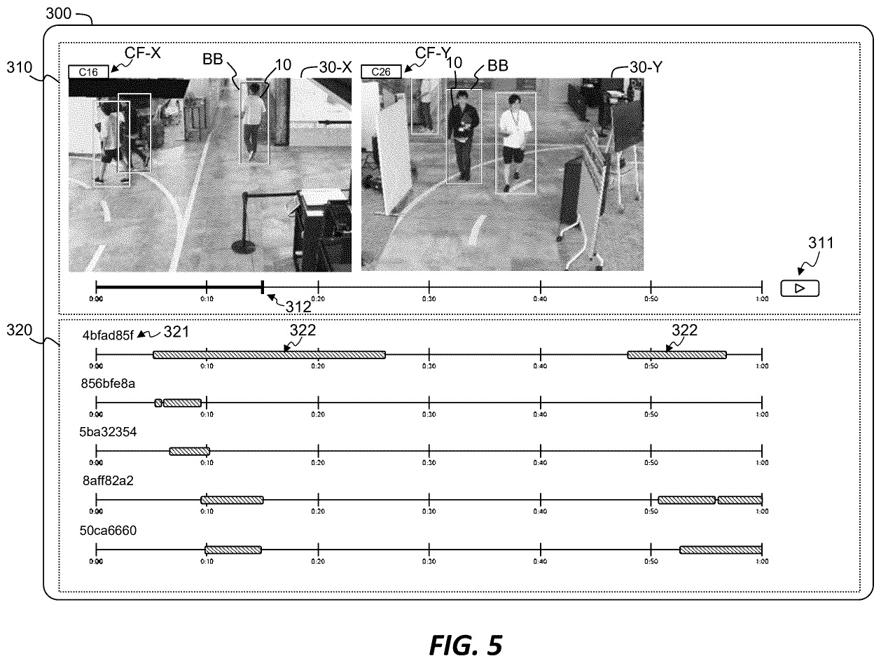

FIG. 5 is a conceptual diagram for explaining a screen configuration of the person tracking screen 300. The person tracking screen 300 includes a first display section 310 and a second display section 320.

The first display section 310 synchronously reproduces and displays one or a plurality of videos 30 during the video time. One or more videos 30 displayed on the first display section 310 are selected by the user 2 from among the videos 30 managed in the video data D10. The person tracking screen display unit F20 receives a selection input of the video 30 from the user 2. The selection input may be performed by selecting the camera 20. For example, the user 2 selects a camera 20 from the list of the plurality of cameras 20, the video 30 of which the user 2 wants to check. In this case, the video 30 captured by the selected camera 20 is displayed on the first display section 310. The person tracking screen display unit F20 may further receive an input of designation of a video time from the user 2. For example, the user 2 designates a period based on the imaging date and time. Hereinafter, each of the one or more videos 30 displayed on the first display section 310 is also referred to as a “monitoring video 30”. In the example illustrated in FIG. 5, two videos 30-X and 30-Y are illustrated as the monitoring video 30.

The first display section 310 displays a button 311 for starting playback of the monitoring video 30 and a bar 312 indicating a playback portion of the monitoring video 30 during the video time. When the user 2 operates the button 311, “synchronous reproduction” of the monitoring video 30 is started. That is, in the first display section, each monitoring video 30 is reproduced while synchronizing the imaging time with each other. When the user 2 operates the button 311 during the reproduction of the monitoring video 30, the reproduction of the monitoring video 30 may be temporarily stopped. The bar 312 moves in accordance with the playback position of the monitoring video 30. The user 2 can recognize the reproduction position of the monitoring video 30 in the video time by checking the position of the bar 312.

A bounding box BB surrounding the identified person 10 is superimposed on each monitoring video 30. In FIG. 5, the reference numerals of the person 10 and the bounding box BB are omitted except for one in each of the videos 30-X and 30-Y. The person tracking screen display unit F20 displays the bounding box BB on each frame of each monitoring video 30 in a superimposed manner by referring to the person identification information IDF. As a modification of the present embodiment, instead of the bounding box BB, a polygon surrounding the person 10 or a skeleton position of the person 10 may be superimposed and displayed on each monitoring video 30 in accordance with the person identification information IDF.

The first display section 310 displays the camera information CF of the camera 20 that captures the monitoring video 30 in association with the monitoring video 30. The camera information CF is information that can identify the camera 20. In the example shown in FIG. 5, the camera information CF is an identification number unique to each camera 20. person tracking screen display unit F20 displays camera information CF by referring to camera information CF included in each monitoring video 30. User 2 can check the arrangement and specification information of camera 20 that captures each monitoring video 30 by referring to the management data of camera 20 based on camera information CF. The camera information CF is information unique to each monitoring video 30. Therefore, each monitoring video 30 can be specified and distinguished from the camera information CF. In the example shown in FIG. 5, camera information CF-X of the camera 20 that captures the video 30-X and camera information CF-Y of the camera 20 that captures the video 30-Y are displayed in association with the video 30-X and the video 30-Y, respectively. As a modification of the present embodiment, other information capable of specifying and distinguishing each monitoring video 30 may be displayed instead of camera information CF. For example, a number indicating the display order of the monitoring video 30 or an identification number unique to each monitoring video 30 may be displayed.

The second display section 320 displays section 322 (hereinafter, referred to as “appearance section 322”) in which one or more identified persons 10 appear in at least one of one or more monitoring videos 30 in the video time for each of one or more identified persons 10. The person tracking screen display unit F20 acquires the appearance section 322 of each person 10 identified in the monitoring video 30 by referring to the person identification information IDF.

In the example illustrated in FIG. 5, the second display section 320 displays a list of the ID321 of each identified person 10. In addition, the second display section 320 displays the appearance section 322 of each person 10 in association with the ID321 of each person 10. In FIG. 5, the reference numerals of the ID321 and the appearance section 322 are omitted except for some of them. By checking appearance section 322 associated with a ID321, user 2 can easily grasp a time point at which person 10 in the ID321 appears in monitoring video 30 during the video time.

### 2-2. Tracking of Target Person in Person Tracking Screen

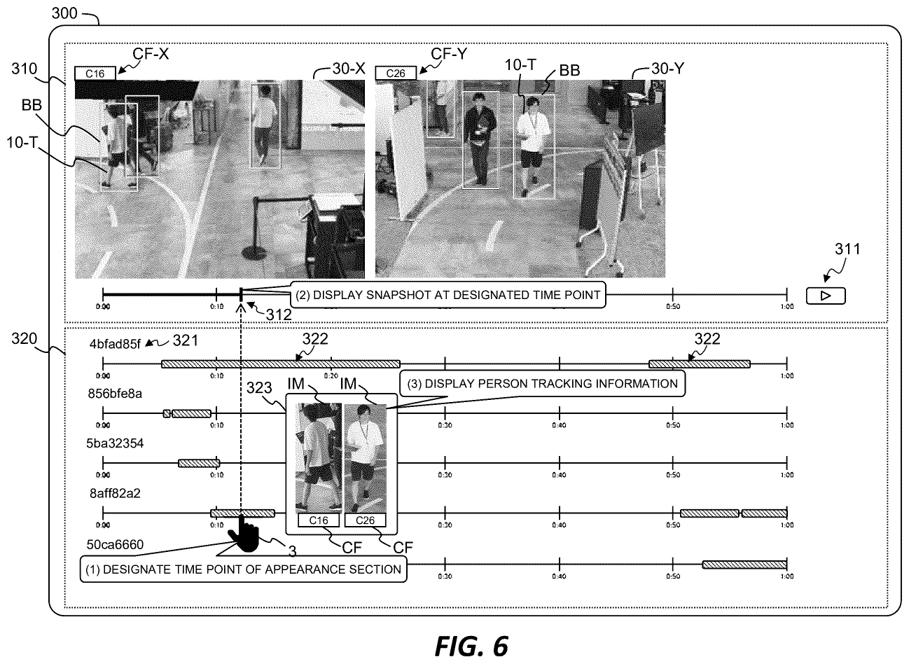

On the person tracking screen 300 having the above-described screen configuration, the user 2 can track the target person 10-T as follows. FIG. 6 is a conceptual diagram for explaining the tracking of the target person 10-T on the person tracking screen 300.

First, the user 2 performs an operation of designating a point in time of the appearance section 322 related to the target person 10-T. For example, the user 2 operates the pointing device to move the pointer 4 over a point in the appearance section 322. In the example illustrated in FIG. 6, a case where the person 10 in the ID321 of “8aff82a2” is the target person 10-T is illustrated.

When the user 2 performs an operation of designating a point in time of the appearance section 322, the first display section displays a snapshot of each monitoring video 30 at the designated point in time. That is, each monitoring video 30 stops at the reproduction position corresponding to the designated time point. The bar 312 may move to a playback location corresponding to the specified point in time. A snapshot may also be referred to as a “still image”.

Further, when the user 2 performs an operation of designating a point in time of the appearance section 322, “person tracking information 323” is displayed on the person tracking screen 300. The person tracking information 323 is information for causing the user 2 to recognize a portion in which the target person 10-T appears in the snapshot. In particular, in the present embodiment, the person tracking information 323 is information in which the image IM obtained by cutting out the region of the bounding box BB surrounding the target person 10-T from the snapshot and the camera information CF of the camera 20 that has captured the monitoring video 30 showing the target person 10-T are associated with each other.

The user 2 can recognize a portion in which the target person 10-T appears in the snapshot of the monitoring video 30 as follows from the person tracking information 323 according to the present embodiment. User 2 can specify monitoring video 30 (target monitoring video) showing target person 10-T by collating camera information CF of the person tracking information 323 with camera information CF associated with each monitoring video 30. In this sense, the camera information CF of the person tracking information 323 can be said to be information for specifying the target monitoring video. Then, the user 2 can recognize a portion in which the target person 10-T appears by comparing the image IM of the person tracking information 323 with the image surrounded by each bounding box BB on the target monitoring video. In this way, the user 2 can easily recognize a portion in which the target person 10-T appears in the snapshot of the monitoring video 30 from the person tracking information 323. In order to make it easier to recognize the portion in which the target person 10-T appears, the person tracking screen display unit F20 may match the color of the bounding box BB surrounding each person 10 and the color of the display of the appearance section 322 related to each person 10.

The user 2 can easily recognize a portion in which the target person 10-T appears at each time point during the appearance section 322 by appropriately changing the time point designated in the appearance section 322 related to the target person 10-T. As described above, according to the present embodiment, the user 2 can efficiently track the target person 10-T on the person tracking screen 300.

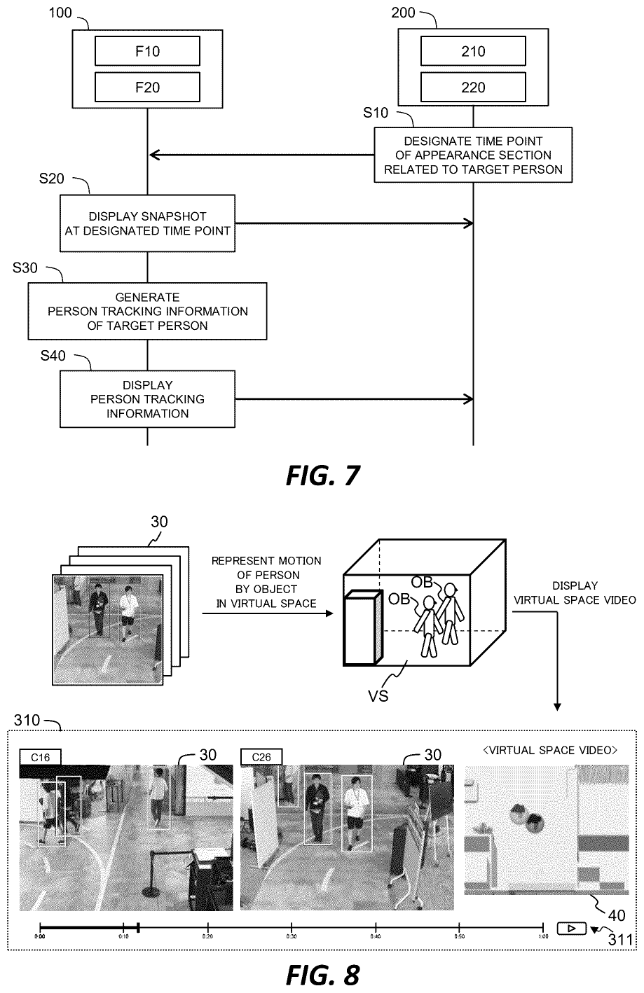

FIG. 7 is a diagram showing a processing sequence in a case where the user 2 tracks the target person 10-T on the person tracking screen 300.

First, in step S10, the user 2 operates the input device 220 to designate a point in time of the appearance section 322 related to the target person 10-T. The operation input by the user 2 is transmitted to the person tracking support device 100.

In response to the designation of the one time point of the appearance section 322, next, in step S20, the person tracking screen display unit F20 displays a snapshot of the monitoring video 30 at the designated one time point on the first display section 310.

Next, in step S30, the person tracking screen display unit F20 generates the person tracking information 323 of the target person 10-T based on the person identification information IDF. To be more specific, the person tracking screen display unit F20 cuts out a region of a bounding box BB surrounding the target person 10-T from the snapshot of the monitoring video 30. Then, the person tracking screen display unit F20 generates the person tracking information 323 by associating the image IM of the region surrounding the cut-out target person 10-T with the camera information CF obtained by capturing the target monitoring video in which the target person 10-T appears.

Next, in step S40, the person tracking screen display unit F20 displays the generated person tracking information 323 on the person tracking screen 300.

### 2-3. Display of Virtual Space Image

The person tracking screen display unit F20 may further display a “virtual space video” on the person tracking screen 300 in order to make the tracing of the target person 10-T by the user 2 more efficient. The virtual space video is a video in which the motion of the person 10 shown in the monitoring video 30 during the video time is represented by an object in the virtual space.

FIG. 8 is a conceptual diagram for explaining the display of the virtual space image 40. The person tracking screen display unit F20 expresses the motion of the person 10 appearing in the monitoring video 30 by the object OB in the virtual space VS. This can be realized by, for example, estimating the 3D posture of the person 10 by applying a known image analysis technique to the monitoring video 30 and reflecting the estimated 3D posture in the object OB. The virtual space VS may be generated in advance. The object OB may be an avatar. The person tracking screen display unit F20 generates a virtual space image 40 showing the virtual space from a predetermined viewpoint. Then, the person tracking screen display unit F20 displays the generated virtual space image 40 on the person tracking screen 300 so as to be synchronously reproduced with the monitoring video 30. In the example shown in FIG. 8, a case where the virtual space image 40 is displayed on the first display section 310 is shown. When the user 2 operates the button 311, the synchronized playback of the virtual space image 40 is started together with the monitoring video 30. The viewpoint of the virtual space image 40 may be arbitrarily changed by the user 2.

By displaying the virtual space image 40 in this way, the user 2 can check the motion of the target person 10-T from various viewpoints through the virtual space image 40. As a result, the user 2 can track the target person 10-T more efficiently.

### 3. Effect

As described above, according to the present embodiment, the person tracking screen including the first display section 310 that synchronously reproduces and displays one or more monitoring videos 30 during the video time and the second display section 320 that displays the appearance section 322 projected on at least one of one or more monitoring videos 30 during the video time for each of one or more identified persons 10 is displayed. Thus, the user can easily determine in which section each person 10 shown in the video 30 is shown. Then, when the user 2 performs an operation of designating one time point of the appearance section 322 related to the target person 10-T, a snapshot of one or a plurality of monitoring videos 30 at the one time point and the person tracking information 323 are displayed. Thus, the user can easily recognize a portion in which the target person 10-T appears at each time point during the appearance section 322. As described above, according to the present embodiment, the efficiency of the tracking work by the user 2 can be improved.

What is claimed is:

1. A person tracking support device comprising:
a storage device configured to store data of a plurality of videos captured by a plurality of cameras; and
processing circuitry, wherein
the processing circuitry is configured to:
identify one or more persons in at least one of the plurality of videos; and
display a person tracking screen on a display device, the person tracking screen including a first display section that synchronously reproduces and displays one or more monitoring videos selected from the plurality of videos during a video time, and a second display section that displays an appearance section for each of the one or more persons, the appearance section being a section in which the person appears in at least one of the one or more monitoring videos during the video time, and wherein
the processing circuitry is configured to, when a user performs an operation of designating a time point of the appearance section related to a target person among the one or more persons on the person tracking screen:
display a snapshot of the one or more monitoring videos at the time point on the first display section; and
display person tracking information on the person tracking screen, the person tracking information being information for causing the user to recognize a portion in which the target person appears in the snapshot.

2. The person tracking support device according to claim 1, wherein
the processing circuitry is further configured to display a bounding box surrounding the one or more persons in a superimposed manner on the one or more monitoring videos displayed on the first display section, and wherein
the person tracking information is information in which an image obtained by cutting out a region of the bounding box surrounding the target person from the snapshot is associated with information for specifying a target monitoring video in which the target person appears among the one or more monitoring videos.

3. The person tracking support device according to claim 2, wherein
the information for specifying the target monitoring video is information of the camera that has captured the target monitoring video among the plurality of cameras.

4. The person tracking support device according to claim 1, wherein
the processing circuitry is further configured to:
generate a virtual space video in which a motion of the one or more persons during the video time is represented by an object in a virtual space; and
display the virtual space video on the person tracking screen so as to be synchronously reproduced with the one or more monitoring videos.

5. A person tracking support device comprising:
a storage device configured to store data of a plurality of videos captured by a plurality of cameras; and
processing circuitry, wherein
the processing circuitry is configured to:
identify a person in each of the plurality of videos; and
cut out a region surrounding the person from snapshot of the video in which the person appears and generate a person tracking information in which an image obtained by cutting out the region surrounding the person from the snapshot is associated with information of the camera that has captured the video in which the person appears among the plurality of cameras.
